(19) United States
(12) Patent Application Publication
(10) Pub. No.: US 2013/0239856 A1
(43) Pub. Date: Sep. 19, 2013

(54) EXTENSIBLE PARTITION AND TABLE USING THE SAME

(71) Applicant: SAMSUNG DISPLAY CO., LTD., Yongin-si (KR)

(72) Inventors: Do-Young Lee, Yongin-si (KR); Oh-Hun Kwon, Seoul (KR); Seon-Hee Gu, Incheon (KR)

(73) Assignee: SAMSUNG DISPLAY CO., LTD., Yongin-si (KR)

(21) Appl. No.: 13/669,062

(22) Filed: Nov. 5, 2012

(30) Foreign Application Priority Data
Mar. 19, 2012 (KR) 20-2012-0002177

(51) Int. Cl. G09F 23/08; A47B 13/08

(52) U.S. Cl. CPC G09F 23/08; A47B 13/08
USPC 108/50.17; 160/238

(57) ABSTRACT

An extensible partition includes a partition including a display area for displaying an image and configured to be rolled, and a roller for rolling the partition, the roller being coupled with a first end of the partition.

### CROSS-REFERENCE TO RELATED APPLICATION

This application claims priority to and the benefit of Korean Patent Application No. 20-2012-0002177 filed in the Korean Intellectual Property Office on Mar. 19, 2012, the entire contents of which are incorporated herein by reference.

### BACKGROUND

(a) Field

Embodiments of the present invention relate to an extensible partition and a table using the same.

(b) Description of the Related Art

In general, partitions are frequently used to divide space in an office, have quadrangular shapes with a height and width, and are continuously connected with each other. Such partitions are only used for partitioning indoor spaces, such as a work area or a desk area, and therefore have a limited purpose.

The above information disclosed in this Background section is only for enhancement of understanding of the background of embodiments of the invention, and therefore may contain information that does not form the prior art that is already known in this country to a person of ordinary skill in the art.

### SUMMARY

Embodiments of the present invention provide an extensible partition for partitioning a space, such as a work space or desk space, in various manners, and for improving or maximizing utility of a display area of the extensible partition.

Embodiments of the present invention provide a table using the extensible partition.

An exemplary embodiment of the present invention provides an extensible partition including a partition including a display area for displaying an image and configured to be rolled, and a roller for rolling the partition, the roller being coupled with a first end of the partition.

The roller support area may be configured to enable the roller of the extensible partition to rotate with respect to the table top plate.

The table top plate may be coupled to at least one support bar combiner configured to be coupled to the support bar of the extensible partition.

The display area may include an organic light emitting diode.

The display area may include two sides, and may be configured to display one or more images on at least one of the two sides.

The roller may be configured to provide an elastic force in a direction in which the partition is configured to be rolled.

The extensible partition may further include a support bar coupled to a second end of the partition.

The support bar may be configured to fix the partition in an unrolled state.

Another exemplary embodiment of the present invention provides a table including the extensible partition, a table top plate coupled to a roller support area for being coupled to the roller of the extensible partition, and legs for supporting the table top plate.

According to embodiments of the present invention, the extensible partition can freely partition the space as desired, and can increase or maximize usage of the space including the display area.

Also, the extensible partition of embodiments of the present invention can be easily rolled and removed when it is not used.

Further, the table can increase or maximize the utility of the space by using the extensible partition.

### BRIEF DESCRIPTION OF THE DRAWINGS

FIG. 1 shows a perspective view of an extensible partition and a table using the same, according to an exemplary embodiment of the present invention.

FIG. 2 shows a perspective view of an extensible partition of the embodiment shown in FIG. 1.

FIG. 3 to FIG. 6 show operations of an extensible partition of the embodiment shown in FIG. 1.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings are schematic, and are not necessarily proportionally scaled down. Relative scales and ratios in the drawings may be enlarged or reduced for the purpose of accuracy and/or convenience, and the scales may be random, and the present invention is not limited thereto. In addition, like reference numerals designate like structures, elements, or parts throughout the specification. Furthermore, it will be understood that when an element is referred to as being “on” another element, it can be directly on another element, or one or more intervening elements may be present therebetween.

The drawings represent exemplary embodiments of the present invention schematically in detail. As a result, various modifications of the drawings are expected. Accordingly, exemplary embodiments are not limited to the specific shapes of shown areas, and, for example, may also include modifications of the shapes shown as a result of manufacturing processes.

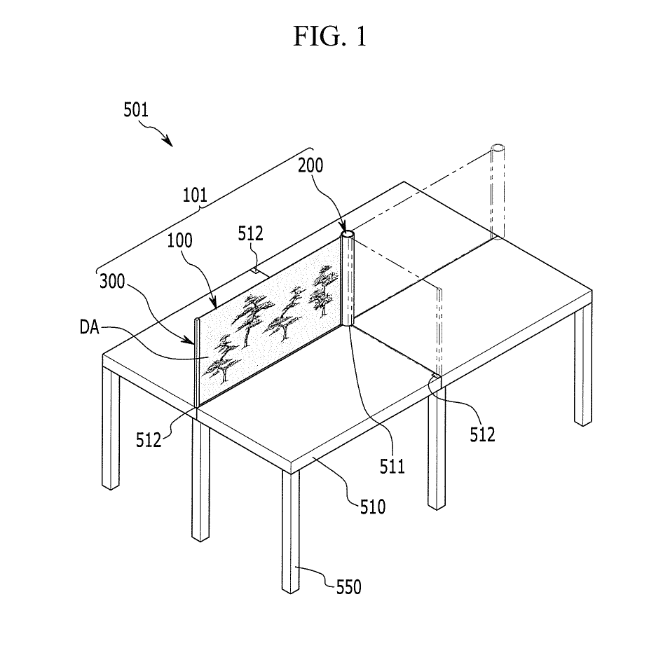

An extensible partition 101 and a table 501 using the same, according to an exemplary embodiment of the present invention, will now be described with reference to FIG. 1 to FIG. 6.

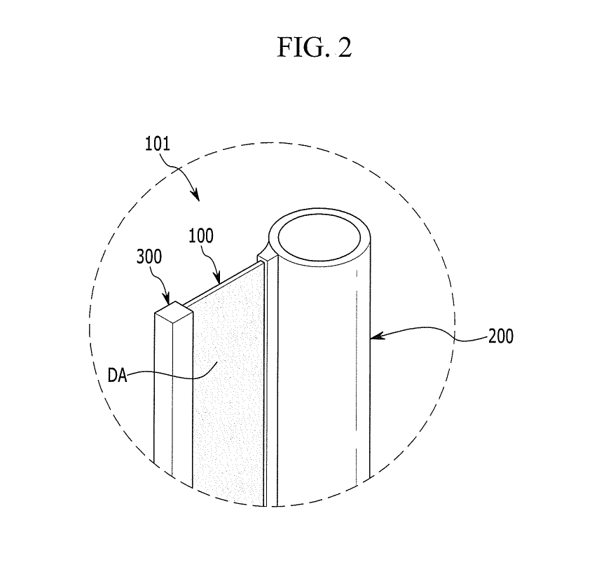

As shown in FIG. 1 and FIG. 2, the extensible partition 101 of the present embodiment includes a partition (e.g., a flexible partition) 100 and a roller 200. The extensible partition 101 further includes a support bar 300 coupled to an end of the partition 100 opposite the roller 200.

The partition 100 can be rolled or unrolled using the roller 200. That is, the partition 100 can be easily unrolled by a user to partition, or divide, a space (e.g., a desk space or a work space), or the partition 100 can be rolled, and can be removed from the space.

The partition 100 of the present embodiment includes a display area (DA). In the present embodiment, as shown in FIG. 1, the partition 100 is formed (e.g., unrolled) to be the display area (DA), although the exemplary embodiment is not limited thereto. That is, a part of the partition 100, or the entire partition 100 can be the display area (DA).

The display area (DA) of the partition 100 can include one or more organic light emitting diodes. That is, the display area (DA) of the partition 100 can be a flexible organic light emitting diode (OLED) display. Various types of organic light emitting diode (OLED) displays that are known to a person skilled in the art can be used for the flexible organic light emitting diode (OLED) display that forms the display area (DA) of the partition 100.

The display area (DA) of the partition 100 can display an image on one side, or can display an image on both sides. Furthermore, different display areas (DA) can be used to display different images on each of the two sides of the partition 100.

The roller 200 is combined with (e.g., coupled to) a first end of the partition 100, and may be used to roll or unroll the partition 100. The roller 200 can provide an elastic force in a direction for rolling the partition 100. The elastic force can be provided by using a known method or device such as, for example, a spring.

As shown in FIG. 2, the roller 200 of the present embodiment uses an inner roller for rolling the partition 100 inside the roller 200 (e.g., the roller 200 includes a housing, or case, for housing the roller 200, and the partition 100 is able to pass through an opening extending a length of the housing/case, enabling the partition 100 to be wound about the roller 200 within the housing/case), although the present invention is not limited thereto. Therefore, the roller 200 of other embodiments can use an outer roller for rolling the partition 100 on an outer side.

The support bar 300 is combined to (e.g., coupled with) a second end of the partition 100, the second end of the partition 100 of the present embodiment being opposite the first end of the partition 100. The support bar 300 can be used as a grip when the partition 100 is unrolled or rolled, and can be used to fix, or hold, the partition 100 while the partition 100 is unrolled.

By the above-described configuration, the extensible partition 101 can freely partition the space as desired by the user, and can increase or maximize utility of the space including the display area (DA). In addition, the extensible partition 101 can be easily rolled up and removed when not being used.

As shown in FIG. 1, the table 501 includes an extensible partition 101, a table top plate 510, and legs 550 that support the table top plate 510.

The table top plate 510 includes a roller support area 511 for supporting the roller 200 of the extensible partition 101 (e.g., the roller support area 511 may be coupled to the roller 200 to hold the roller 200 in place with respect to the table top plate 510). In the present embodiment, the roller 200 of the extensible partition 101 is supported on the table top plate 510 in a rotatable manner. The table top plate 510 of the present embodiment includes at least one support bar combiner 512 to which the support bar 300 of the extensible partition 101 can be combined or coupled. When the table top plate 510 includes a plurality of support bar combiners 512, the extensible partition 101 can be selectively unrolled in one of several directions as desired by the user to easily partition the space. The display area (DA) of the partition 100 can be oriented in a direction desired by the user.

According to the above-described configuration, the table 501 can improve or maximize the use of the space (e.g., the work space of the table 501) by using the extensible partition 101.

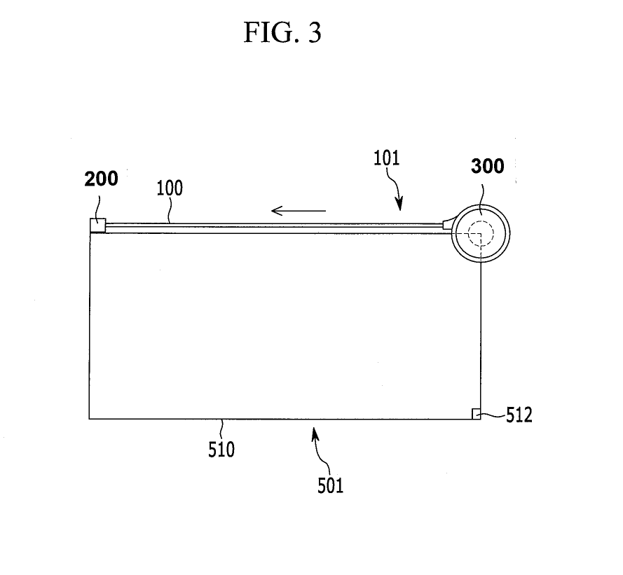

An operation of the extensible partition 101 of the present embodiment provided on a table will now be described with reference to FIG. 3 to FIG. 6.

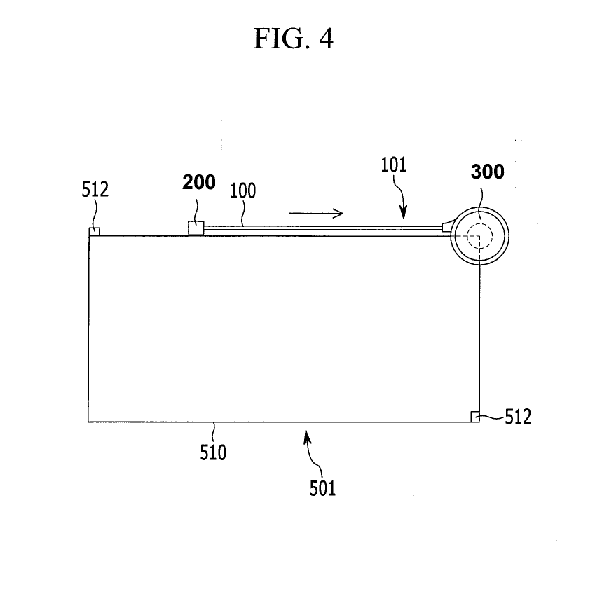

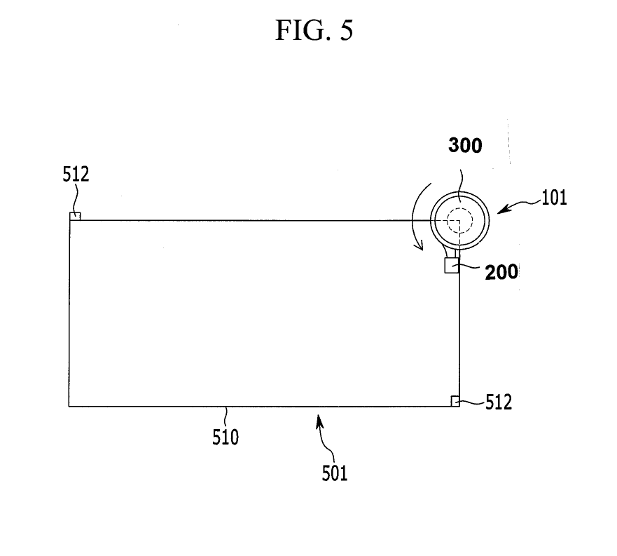

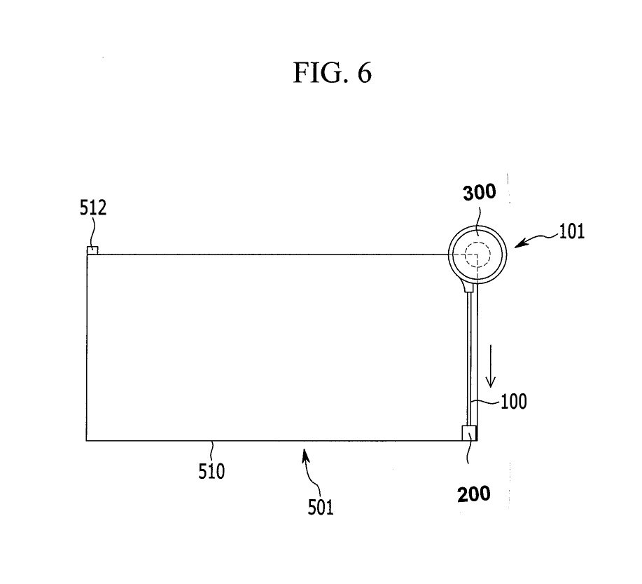

The partition 100 partitioning the space on the table 510, as shown in FIG. 3, can be rolled by the roller 200, as shown in FIG. 4. The roller 200 may be rotated, as shown in FIG. 5, and the rolled partition 100 may then be unrolled in another direction to partition another space, as shown in FIG. 6.

Further, the display area (DA) of the partition 100 can be freely oriented at desired positions according to the above-described operation.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and their equivalents.

1. A table configured to be coupled to an extensible partition comprising: a partition comprising a display area for displaying an image, and configured to be rolled; and a roller for rolling the partition, the roller being coupled with a first end of the partition, the table comprising:
a first support configured to be coupled to a second end of the partition when the partition is extended in a first direction, and
a second support configured to be coupled to the second end of the partition when the partition is extended in a second direction.

2. The table of claim 1, further comprising:
a table top plate coupled to a roller support area for being coupled to the roller of the extensible partition; and
legs for supporting the table top plate.

3. The table of claim 2, wherein the roller support area is configured to enable the roller of the extensible partition to rotate with respect to the table top plate such that the roller is in a first position when the partition is extended in the first direction, and such that the roller is in a second position when the partition is extended in the second direction.

4. The table of claim 3, wherein the table top plate is coupled to at least one support bar combiner configured to be coupled to a support bar of the extensible partition.

5. The table of claim 1, wherein the display area comprises an organic light emitting diode.

6. The table of claim 5, further comprising:
a table top plate coupled to a roller support area for being coupled to the roller of the extensible partition; and
legs for supporting the table top plate.

7. The table of claim 5, wherein the display area comprises two sides, and is configured to display one or more images on at least one of the two sides.

8. The table of claim 7, further comprising:
a table top plate coupled to a roller support area for being coupled to the roller of the extensible partition; and
legs for supporting the table top plate.

9. The table of claim 1, wherein the roller is configured to provide an elastic force in a direction in which the partition is configured to be rolled.

10. The table of claim 9, further comprising:
a table top plate coupled to a roller support area for being coupled to the roller of the extensible partition; and
legs for supporting the table top plate.

11. The table of claim 1, further comprising a support bar coupled to the second end of the partition and configured to be coupled to the first and second supports.

12. The table of claim 11, further comprising:
a table top plate coupled to a roller support area for being coupled to the roller of the extensible partition; and
legs for supporting the table top plate.

13. The table of claim 11, wherein the support bar is configured to fix the partition in an unrolled state.

14. The table of claim 13, further comprising:
a table top plate coupled to a roller support area for being coupled to the roller of the extensible partition; and
legs for supporting the table top plate.
